(19) United States
(12) Patent Application Publication
(10) Pub. No.: US 2018/0047093 A1
(43) Pub. Date: Feb. 15, 2018

(54) SELF-SERVICE VIRTUAL STORE SYSTEM

(71) Applicant: Wal-Mart Stores, Inc., Bentonville, AR (US)

(72) Inventors: Donald R. High, Noel, MO (US); John J. O'Brien, V, Farmington, AR (US); Eugene Sunday, Glen Ellyn, IL (US)

(21) Appl. No.: 15/666,873

(22) Filed: Aug. 2, 2017

Related U.S. Application Data
(60) Provisional application No. 62/372,490, filed on Aug. 9, 2016.

(51) Int. Cl. G06Q 30/06; G06F 3/01; G06T 15/00; G06T 19/20

(52) U.S. Cl. CPC G06Q 30/0643; G06Q 30/0633; G06T 19/20; G06F 3/016; G06T 15/005; G06F 3/04815

(57) ABSTRACT

Provided is a self-service virtual store system. The self-service virtual store includes a server comprising a memory, a database stored in the memory, and a processor, wherein the database contains data for a 3D virtual store front, wherein the data for the 3D virtual store front comprises data including a plurality of visually perceptible elements, which visually perceptible elements correspond to the 3D virtual store front, particular items in the 3D virtual store front, and avatars. The self-service virtual store includes a computer coupled to the server wherein a user interfaces with the server through the computer. The server is programmed to provide to users a virtual shopping experience in a virtual environment, wherein users utilize avatars to move within the virtual environment and perform shopping function.

### CROSS REFERENCE TO RELATED APPLICATION

This invention claims priority to U.S. provisional patent application Ser. No. 62/372,490, filed Aug. 9, 2016 to Applicant Wal-Mart Stores Inc., and entitled “SELF-SERVICE VIRTUAL STORE SYSTEM”, which is included entirely herein by reference.

### FIELD OF THE INVENTION

The invention relates generally to virtual stores, and more specifically, to systems and methods for providing a self-service virtual store.

### BACKGROUND

There are two primary shopping options available to a customer who wishes to purchase a store item. The first includes the physical presence of the customer at a retail establishment, referred to as a “brick-and-mortar” store. The second shopping option is referred to as “online shopping” where the customer can purchase store items over the Internet. Here, the purchased items are mailed to a location designated by the online customer. With online and brick-and-mortar shopping, there is a lack of intuitive shopping. Shoppers must browse through predesigned layouts, and the customer is often the products displayed in the predesigned layouts are not what the customers are looking for.

### BRIEF SUMMARY

In one aspect, provided is a system for providing a self-service 3D virtual store, the system comprising: a server comprising a memory, a database stored in the memory, and a processor, wherein the database contains data for a 3D virtual store front; wherein the data for the 3D virtual store front comprises data including a plurality of visually perceptible elements, which visually perceptible elements correspond to the 3D virtual store front, particular items in the 3D virtual store front, and avatars; a computer coupled to the server wherein a user interfaces with the server through the computer, wherein the server is programmed to: display the 3D virtual store front on the computer coupled to the server; receive from the computer a signal indicating entrance within the 3D virtual store front; automatically displaying on the computer coupled to the server A) an avatar associated with the user within the 3D virtual store front on the computer coupled to the server, and B) items for sale within the 3D virtual store, wherein the items are scalable and displayed on virtual shopping displays, racks and shelves; receive from the computer a signal indicating selection of one of the items within the 3D virtual store front; automatically creating and displaying a 3D virtual item in response to processing the data including the plurality of visually perceptible elements corresponding to the selected 3D virtual item; receive from the computer a signal indicating interaction between the avatar and the selected 3D virtual item; and automatically displaying in response to receiving the signal indicating interaction between the avatar and the selected item and processing the data including the plurality of visually perceptible elements corresponding to the selected item and avatar a dynamic and scalable 3D representation of rotating, manipulating and emulating interaction between the avatar and the selected item.

In another aspect, provided is a system for providing a self-service 10D virtual store, the system comprising: a server comprising a memory, a database stored in the memory, and a processor, wherein the database contains data for a 10D virtual store front; wherein the data for the 10D virtual store front comprises data including a plurality of visually perceptible elements, which visually perceptible elements correspond to the 10D virtual store front, particular items in the 10D virtual store front, and avatars; a computer coupled to the server wherein a user interfaces with the server through the computer, wherein the server is programmed to: display the 10D virtual store front on the computer coupled to the server; receive from the computer a signal indicating entrance within the 10D virtual store front; automatically displaying on the computer coupled to the server A) an avatar associated with the user within the 10D virtual store front on the computer coupled to the server, and B) items for sale within the 10D virtual store, wherein the items are scalable and displayed on virtual shopping displays, racks and shelves; receive from the computer a signal indicating selection of one of the items within the 10D virtual store front; automatically creating and displaying a 10D virtual item in response to processing the data including the plurality of visually perceptible elements corresponding to the selected 10D virtual item; receive from the computer a signal indicating interaction between the avatar and the selected 10D virtual item; and automatically displaying in response to receiving the signal indicating interaction between the avatar and the selected item and processing the data including the plurality of visually perceptible elements corresponding to the selected item and avatar a dynamic and scalable 10D representation of rotating, manipulating and emulating interaction between the avatar and the selected item.

### BRIEF DESCRIPTION OF THE SEVERAL VIEWS OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is a block diagram of a virtual store front, in accordance with embodiments.

FIG. 2 is a block diagram of a virtual store front that is scalable, in accordance with some embodiments.

FIG. 3 is a block diagram of a virtual store front with collaborative shopping, in accordance with some embodiments.

FIG. 4 is a block diagram illustrating a haptic feedback system, in accordance with some embodiments.

FIG. 5 is a block diagram of a 3D scanner, in accordance with some embodiments.

FIG. 6 is a block diagram of a virtual purchasing system, in accordance with some embodiments.

FIG. 7 is a block diagram of a virtual assistant and virtual expert, in accordance with some embodiments.

FIG. 8 is a perspective view of a haptic feedback device, in accordance with some embodiments.

FIG. 9 is a diagrammatic view of a spray device, in accordance with some embodiments.

### DETAILED DESCRIPTION

Many store customers prefer to shop online. Online customers enjoy a customized and expedient shopping experience that is typically not offered at a brick-and-mortar store. For example, online customers can order items online at any time, thereby avoiding the time-consuming effort of being physically present at the store to select items of interest from shelves and waiting in line at the store checkout to purchase the items especially at peak times. Also, online customers typically have immediate access to their purchase history, and can receive a display of recommended items for purchase based on shopping patterns or other purchase history information.

Brick-and-mortar stores provide customers the ability to walk about the store, perusing items of interest, touching items for purchase, smelling items, listening to items, trying on items determining spacial qualities of the items, etc. It provides a “hands on” shopping experience that is not available to currently existing online shopping systems.

The present inventive concepts combine the benefits of offline shopping with online features by introducing a self-service virtual store providing a walk about the store, perusing items of interest, touching items for purchase, smelling items, listening to items, trying on items determining spacial qualities of the items, etc. in a virtual environment.

With reference to the drawings, each of the drawing figures is directed to a system or method for providing a self-service 3D virtual store. Generally, the system includes a server comprising a memory, a database stored in the memory, and a processor, wherein the database contains data for a 3D virtual store front. The data for the 3D virtual store front comprises data including a plurality of visually perceptible elements, which visually perceptible elements correspond to the 3D virtual store front, particular items in the 3D virtual store front, and avatars. The system also includes a computer coupled to the server wherein a user interfaces with the server through the computer. The drawing figures are directed to the programming of the server of the system.

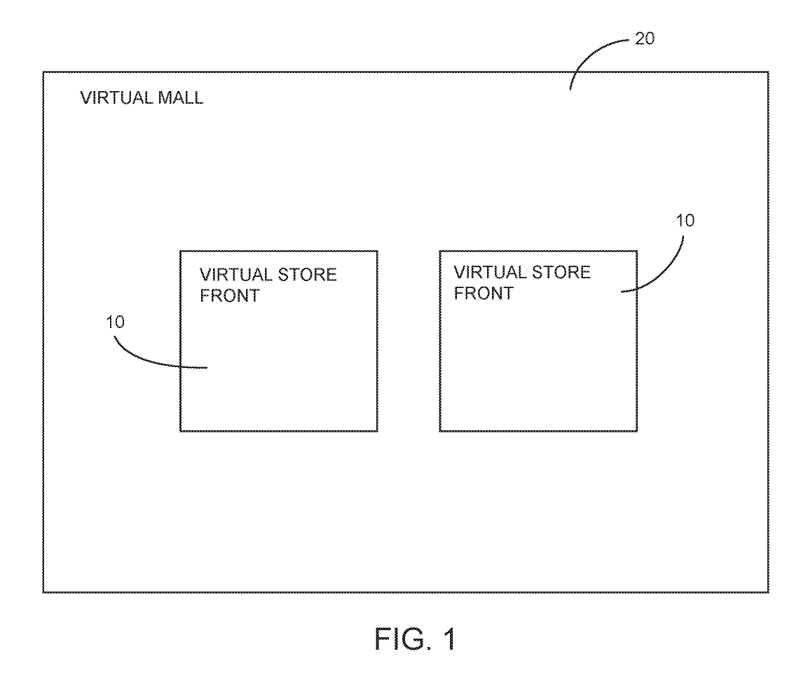

FIG. 1 depicts a block diagram of a virtual store front 10, according to an embodiment. The virtual store front 10 may include a pseudo-physical version of a virtual store location. This pseudo-physical version of a virtual store location, or shopping environment may be dynamically changeable to allow elements within the virtual store to be tailored to the retailer's desire. This is also beneficial for the customer experience during shopping in a virtual store within a virtual world.

The virtual store front 10 may be within a virtual mall 20. This mall 20 may be a collection of a plurality of store fronts 10. These store fronts 10 will be displayed within the virtual mall 20. In embodiments, the entity operating the system may operate the virtual mall 20, wherein the virtual mall 20 includes virtual real estate forming the virtual store fronts 10, wherein retailers may purchased the virtual store fronts 10 for a particular price. The price of the virtual store front 10 may be determined based on size of the virtual store front, based on the amount of virtual products that will be displayed and sold in the virtual store front, and the like.

The various store fronts 10 of the virtual mall 20 may be dynamically changed, moved or searched. This may be accomplished through interaction with the server through the computer, wherein the computer includes various forms of input/output, such as hand gestures, audio control, virtual movements, search query, etc. Further, store fronts 10 may be featured from selections made by the customer, wherein the system dynamically designates the store fronts 10 that sell the product(s) searched for by the customer.

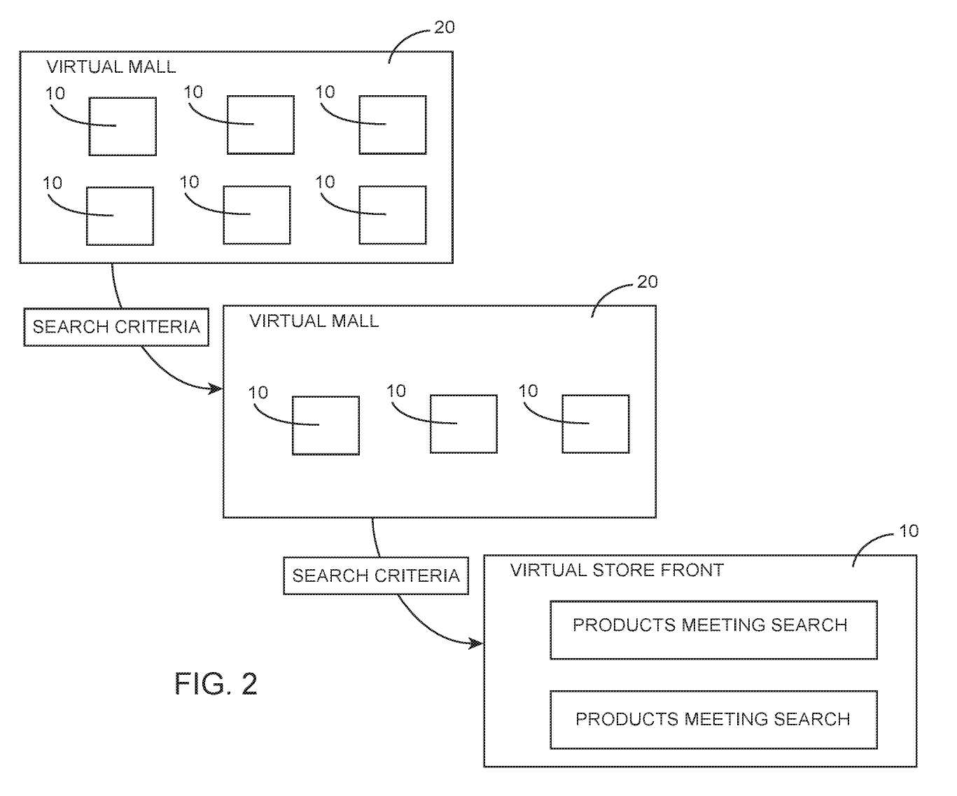

Referring further to the drawings, FIG. 2 depicts a block diagram of a virtual store front 10 that may be scaled and/or dynamically scaled according to embodiments. The various store fronts 10 of the virtual mall 20 may be dynamically changed, moved or searched. This may be accomplished through interaction with the server through the computer, wherein the computer includes various forms of input/output, such as hand gestures, audio control, virtual movements, search query, etc. Further, store fronts 10 may be featured from selections made by the customer, wherein the system dynamically designates the store fronts 10 that sell the product(s) searched for by the customer.

Virtual store fronts 10 may be able to scale to the user's specified selections, or will be able to scale on the premise of their gathered data or previous selections. For example and without limitation, if a user is shopping for a particular product, the system providing the virtual environment may exclusively display only store fronts 10 that offer that particular product, thereby scaling the virtual mall 20 to only the store fronts 10 meeting the search criteria. Depending on the selection of the customer, the virtual mall 20 and/or virtual store front 10 may be scaled further or condensed further by adding more criteria to the search. For example, and without limitation, if a user is shopping for a movie, the virtual mall 20 may be dynamically scaled to only display store fronts 10 that sell movies. The customer may enter the virtual store front 10 by operating an avatar associated with the customer, the avatar being in the virtual world having the virtual mall 20. The customer may then search for a particular genre of movie and the virtual store front 10 that the avatar is within ma ten be dynamically scaled to only display movies within that particular genre. Additional search criteria added to the existing search terms or criteria will further scale the store front 10. While the additional dynamically scaling has been described with respect to a store front 10, it is understood that the virtual mall 20 may be scaled further based on additional search criteria added to existing search criteria to scale the virtual mall 20 to only depict the store front(s) 10 meeting the more detailed search criteria.

Dynamic scaling of a store front 10 allows a customer to browse through a store front 10 as a customer would browse in a brick and mortar store, or the customer may be virtually taken directly to a specified product or selection of products without having to navigate throughout the store. This can be accomplished through any one of the following navigational tools available through inputs/outputs on the computer coupled to the server, wherein the customer accesses the system through the computer. The inputs/outputs of the computer includes audio, gesture control, virtual movement, search query, etc.

In embodiments, the server may be programmed to allow the customer to create a customer store that features products the customer typically buys from various store fronts 10 all in one customer store. Customers can invite other people to shop in their store, and can even set licenses with producers to be able to display products in their stores. Customers can select other products they sell, and become surrogate associates selling products to customers, many of whom might not otherwise shop at a particular store front 10. Sales may be fulfilled by the store front 10 or, in other embodiments, the store front 10 may receive a royalty for other products added to the store in the virtual mall 20 in the virtual environment that store front 10 does not actually carry.

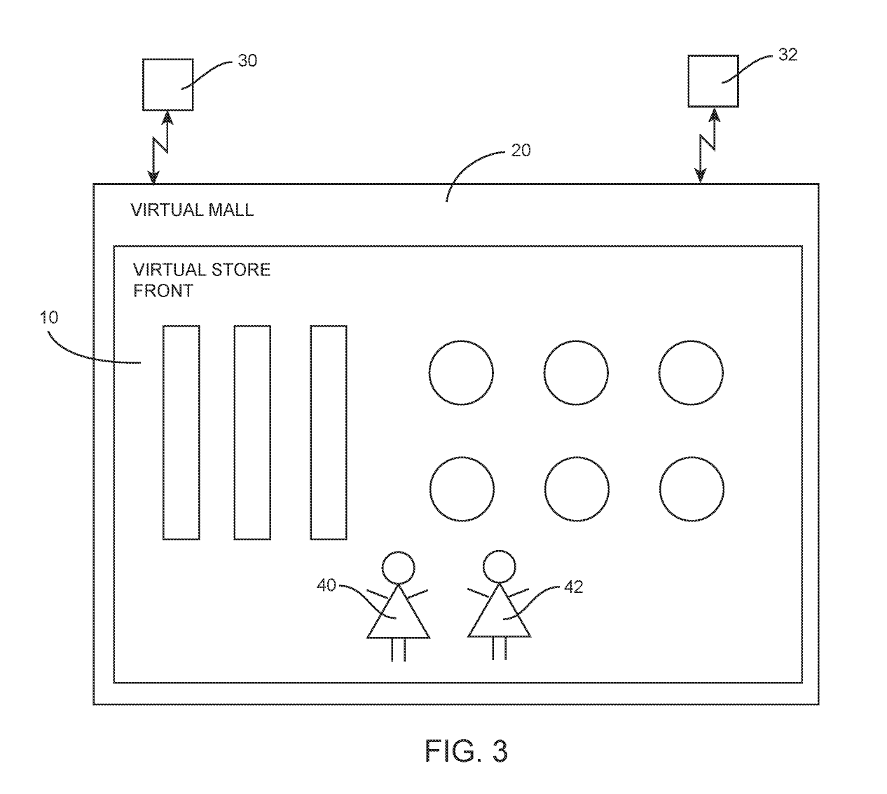

Referring to FIG. 3, depicted is a block diagram of a virtual store front 10 with collaborative shopping, in accordance with embodiments. The server may be programmed to provide shopping with other users, wherein multiple users may shop and engage with other users within the virtual mall 20. Despite geolocation separation, a user 30 will be able to engage, shop and interact with other another user 32 within the virtual mall 20.

By way of example, and not by way of limitation, user 30 may be located in the United States and the user 32 may be located in Korea, for example user 32 may be the mother of user 30. User 30 may want to shop with user 32, such as a daughter shopping with her mother, wherein the user 30 and user 32 shop together within the virtual mall 20. This would be accomplished by the user 32 connecting into the virtual mall 20 through a computer, and then the user 30 would connect into the virtual mall 20 and with user 32 through a computer and enter into the virtual store front 10 of virtual mall 20. At that point, user 30 and user 32 may browse throughout the various store fronts 10 within virtual mall 20. User 30 and user 32 may view products throughout the store 10 or mall 20 together. They could try on clothing together or interact with the various products displayed; they could purchase items for each other, and the like.

The server may be programmed to provide various types of shopping experiences. For example, these shopping experiences may be private or may be a public domain. In private shopping experiences, users can invite other users to their private shopping experience. In public cases, users can browse through the virtual mall 20 with other users that are shopping in a public environment. The users in each the private or public shopping experience may interact with the users within the private or public shopping experience. Within these private or public shopping experiences, users with personal preferences and personal stores can combine their preferences or stores with other users during a joint session to create a custom experience respecting their shared interests and differences.

Users may interact with others users within the virtual shopping experience; these interactions will allow users to be able to speak, exchange, feel, hear, express, share, etc. In some embodiments, groups of users that interact can be autonomously selected by the virtual shopping experience. In another embodiment, groups can be selected by users based on a list of users they chose to have access to the group. In yet another embodiment, groups can be specified for a certain group type, such as but not limited to: geographic location, interest, etc.

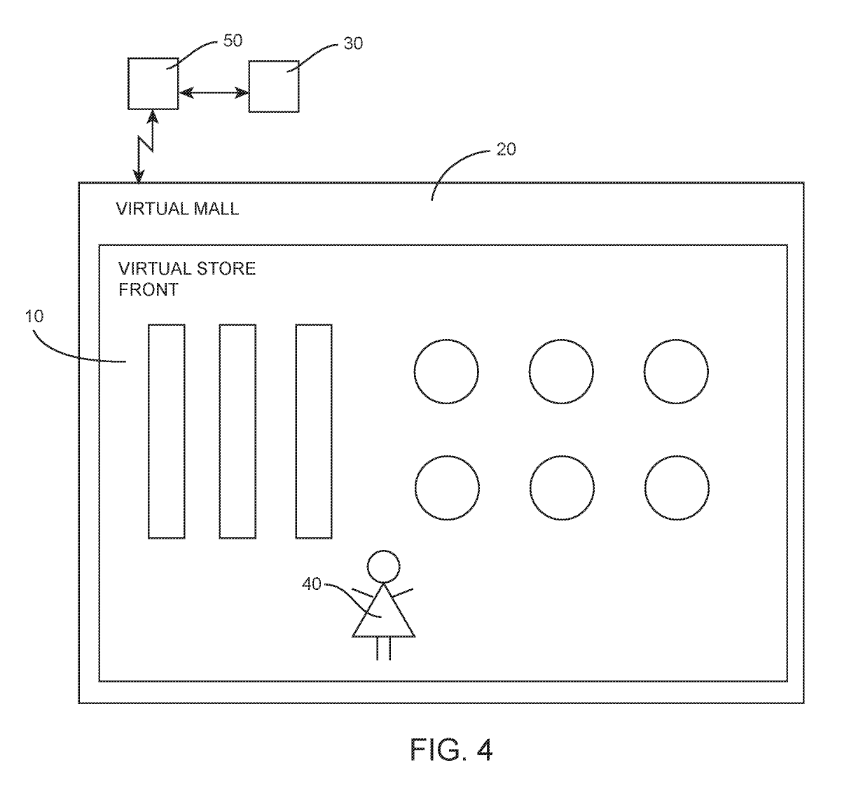

Referring to FIG. 4, the system may include haptic feedback interaction for user 30 within the virtual store front 10. Through the integration of haptic systems within the virtual environment, users within the virtual system will receive haptic feedback from their interactions within the virtual environment. Any type of haptic feedback system may be utilized with the system for interaction with the virtual environment within which is the virtual mall 20 and virtual store front 10. An example, and not as a limitation, includes user 30 wearing a full-body haptic feedback system 50. User 30 may operate the avatar 40 associated with user 30 to try on clothing. The full-body haptic system 50 may provide feedback to user 30 of the clothing fitting to the user 30. In some embodiments, the user 30 may elect to shop for another person and the server may be programmed to receive measurements for the elected person being shopped for. The haptic feedback system 50 may operate to provide user 30 with the feedback that the elected person would feel wearing the clothing. In this way, the user 30 can receive haptic feedback from another user's measurements for which they are trying and purchasing clothing for.

In addition to haptic feedback system, the virtual shopping experience may include sensory emulation integration. Sensory emulation integration may provide user 30 in the virtual shopping experience with the ability to smell, taste, touch and feel objects within the virtual shopping experience. Sensory emulation integration may allow user 30 to twist the cap of a gallon of orange juice and smell the contents therein, to feel the texture and fabric of articles of clothing within the virtual shopping experience, and the like.

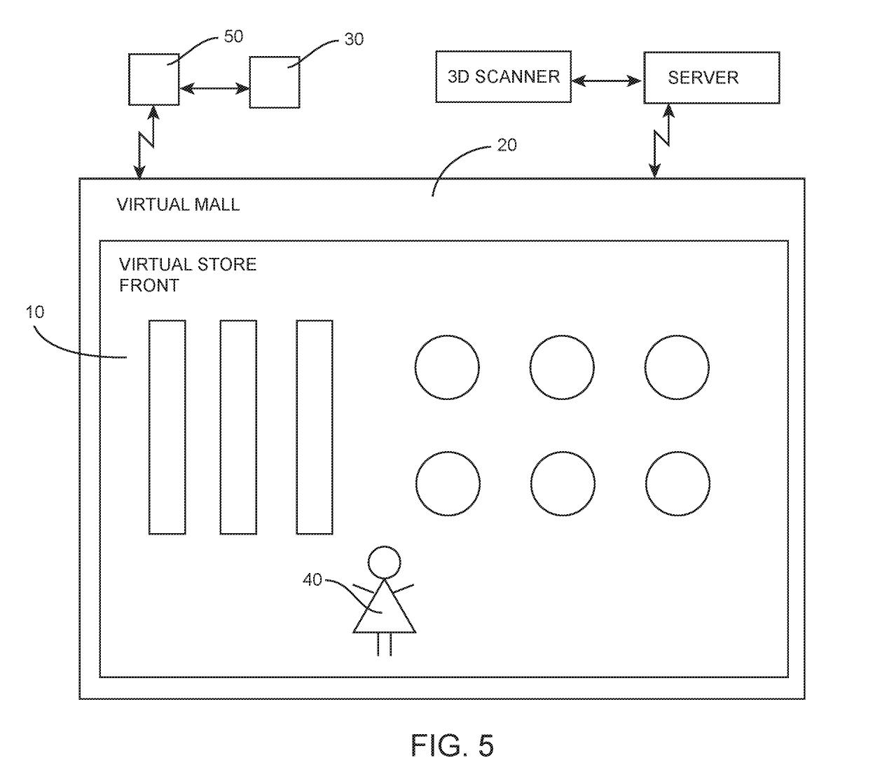

In embodiments, FIG. 5 depicts a block diagram of a scan of user 30 to create a physical profile scanned into the virtual environment. For example, a scanner may include 3D body scanning technologies, such as, but not limited to Xbox Kinect, Styku, etc. User 30 may be able to scan her physical profile into the virtual environment. This information may then be uploaded and stored in the server and provided for use in the virtual shopping experience. The server may then be programmed to automatically adjust the 3D avatar 40 of user 30 to her physical profile. The information determined by the 3D scan and stored in the server may include, but is not limited to size, weight, height, body fat, skin tone, shape, tone, etc.

After a user 30 has uploaded her 3D body scan into the server that provides the virtual shopping experience, user 30 will be able to adjust this information. For example and without limitation, user 30 may adjust the information for predictive weight loss, wherein the user 30 will be able to make adjustments to her virtual avatar 40 to predict weight losses or gains. This allows the user 30 to try on clothing with a predicted weight loss or gain measurement. Another example includes user 30 may adjust the information for predictive growth display, wherein the user 30 will be able to make adjustments to her virtual avatar 40 to predict growth. The user 30 will be able to try on clothing with a predicted growth, to provide the user 30 with accurate information on how clothing will fit with their anticipated growth.

In embodiments, user 30 may dynamically change her avatar 40 to another user avatar 42. This allows the user 30 to be able to assume the profile of the avatar 42 they have chosen; which will allow them to use the measurements the chosen avatar 42. For example, without limitation, a mother that is user 30 will be able to switch to the avatar 42 of her son. By doing do, a mother will be able to shop for clothing for her son while physically being herself yet in the virtual environment her avatar's 40 measurements will change to her son as avatar 42. In this way, when she tries on a shirt, the avatar 42 will show the shirt's fitting to the measurements of her son. In embodiments, haptic feedback systems may also dynamically demonstrate this fitting. In another example, user 30 may shop for food products for another user, wherein by dynamically changing her avatar 40 to another user avatar 42, user 30 may be provided with information regarding the other user's personal preferences, including dietary restrictions, allergens, brand selections, etc., thereby allowing user 30 to shop for another based on the other user's preferences and profile.

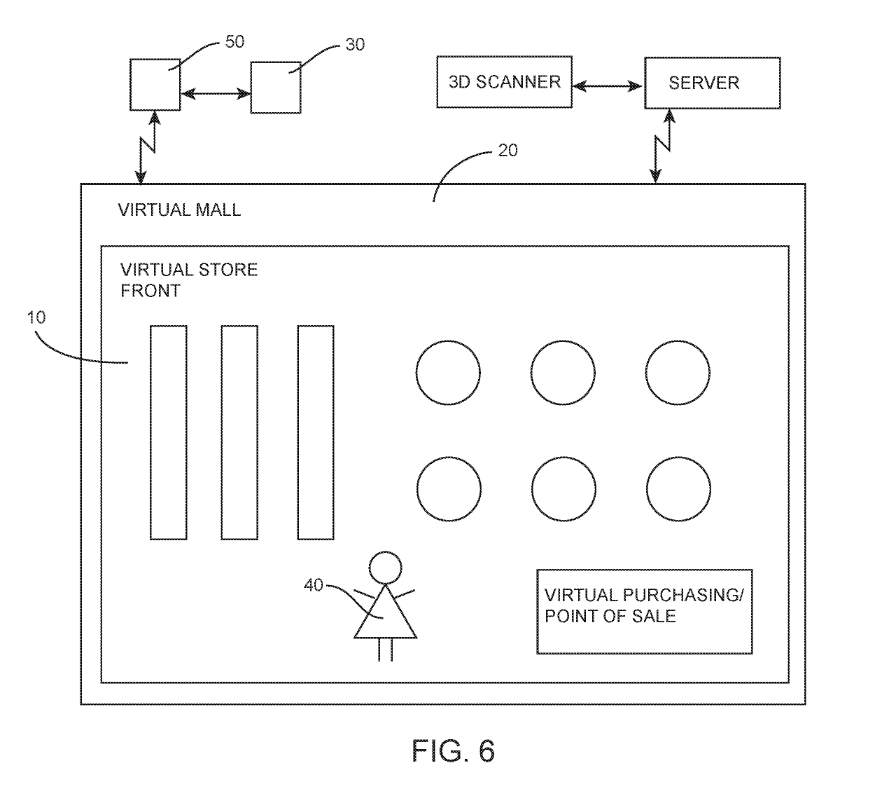

In embodiments, as depicted in FIG. 6, the system may include virtual purchasing. Users of the virtual shopping system may be able to allow other users to use their finances for purchases. The permission of the use of finances can be exclusive for specific purposes, such as, but not limited to specific products, time, place, etc. For example, and without limitation, a mother could allow her daughter to use her finances to purchase items within the virtual shopping experience but this could be limited to only clothing purchases made on a specified date.

In embodiments, users of the virtual shopping system will be able to create lists of items for which they would like to have purchased as a gift. This will add significant convenience when purchasing a gift for another user. These lists can be made available to the public or can be privately set for only specific users to view.

In embodiments, users of the virtual shopping system will be able to cooperatively purchase items together. This allows users of the system to split the costs during a virtual shopping trip.

Within the system, a user 30 may include a 3D Avatar virtual clothing display, wherein user 30 within the virtual environment will be able to try on clothing just like user 30 would in a physical environment. The user 30 will also receive feedback from haptic systems, which display the fitting of the clothing on the user's 30 avatar 40. User 30 can manipulate her avatar 40 to see how user looks, and export an image of that avatar 40 to friends through social media or other means to garner opinions.

In addition to clothing, the system allows avatar 40 to interact with other objects in the virtual shopping experience. User 30 may access the virtual environment through a computer and utilize the avatar 40 within the virtual environment will be able to interact with objects in the virtual environment with user's 30 avatar 40. This interaction provided by the system will allow users to touch, feel, smell, taste, hear and see objects for purchase as the user would in a physical environment. Users will be able to manipulate the original context of items within the virtual environment; they will able to change the size, shape, color, texture, etc.

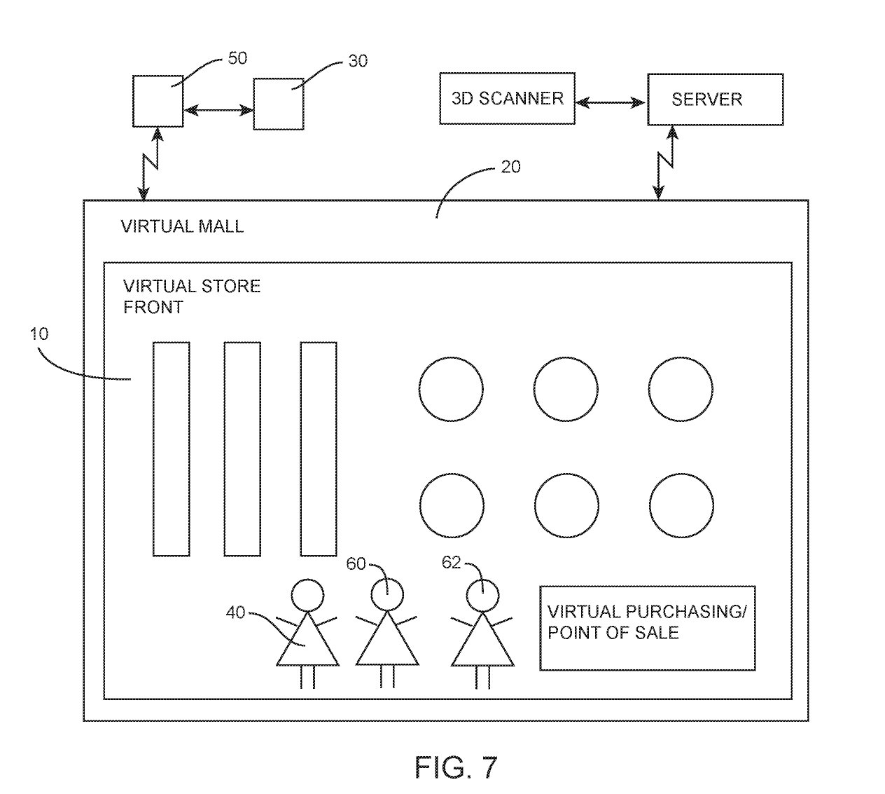

FIG. 7 depicts a block diagram view of a virtual assistant 60 and virtual shopping experts 62. Virtual assistant 60 and virtual experts 62 may be available to customers within the virtual shopping experience. These virtual assistants 60 and virtual experts 62 may provide an expertise on products and services to assist the customer in finding the needed knowledge for an accurate purchase. These assistants 60 and virtual experts 62 may also provide suggestions for purchases, wherein the assistants 60 and virtual experts 62 operate through artificial intelligence and physiological cues to assist the customer in the decision process for the purchase.

An example includes, without limitation, a customer browses a particular section of goods, such as a tie section of a virtual store front 10. A virtual assistant 60 may appear and ask the user 30 what the user 30 is looking for and present assortments of ties or other goods. If the customer has stored information within the server regarding the user's 30 tie buying history, the virtual assistant 60 may use this information to provide suggestions. If the user 30 has difficulty in making a decision on what tie to purchase, the virtual assistant 60 will respond to customer delay, providing assistance in making a decision for the purchase. Virtual assistants 60 can be autonomous avatars that are displayed by artificial intelligence. In other embodiments, virtual assistants 60 can be users' avatars, allowing users to work as virtual assistants 60 within the virtual shopping experience. Additionally, virtual assistants 60 can be holographic displays that are displayed by artificial intelligence.

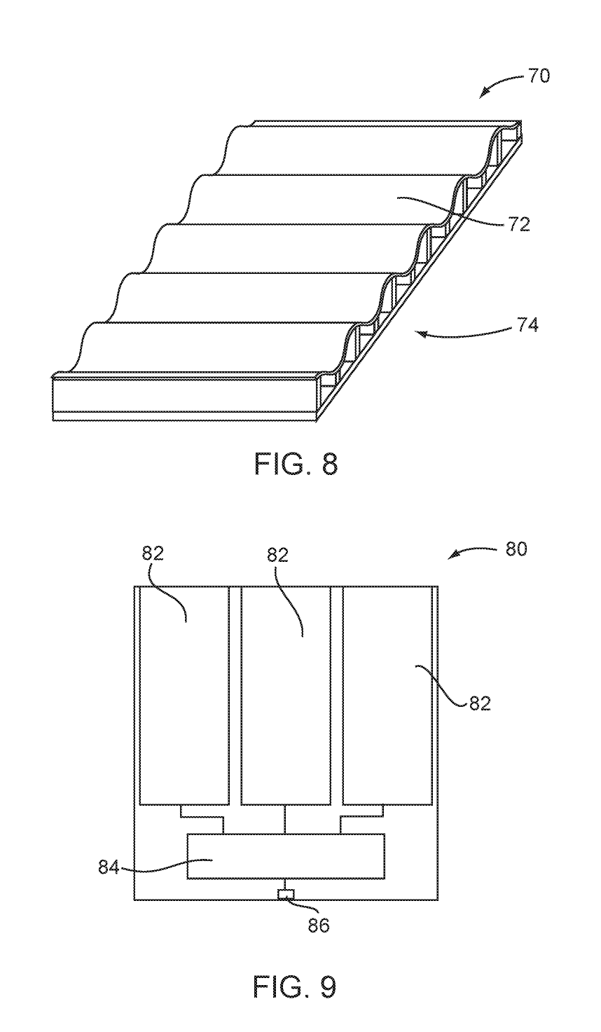

FIG. 8 depicts a perspective view of a haptic feedback device 70 in accordance with embodiments. The haptic feedback device 70 may include a flexible touchscreen display 72 with 3D touch capability and mechanical components 74 coupled to the flexible touchscreen display 72. The server may be programmed to move the mechanical components 74 to manipulate the flexible touchscreen display 72 to provide physical texture changes to the flexible touchscreen display 72. The 3D touch capabilities may operate with the mechanical components 74 to provide touch sensory emulation. For example, and without limitation, the mechanical components 74 may be a plurality of rods coupled to the flexible touchscreen display 72, wherein the plurality of rods are in a parallel configuration. The rods may move in response to instruction provided by the server to move and physically manipulate the flexible touchscreen display 72 to provide a particular feel of surface type associated with a selected item in the virtual store. The haptic device 72 may then combine the physical manipulation of the flexible touchscreen display with the 3D touch capability to emulate the touch and feel of the selected item. For example corduroy material and other types of material or surface properties.

Another embodiment of the mechanical components 74 may be a plurality of small members that have an end coupled to the flexible touchscreen display 72. The small members may be arranged in an array with a certain amount of resolution or small members per square inch, to allow for fine tuning of the material types that being emulated. The server may then provide the instructions on how to move some or all of the plurality of small members to physically manipulated the flexible touchscreen display 72 to provide a particular feel of surface type associated with a selected item in the virtual store. The haptic device 72 may then combine the physical manipulation of the flexible touchscreen display 72 with the 3D touch capability to emulate the touch and feel of the selected item.

Yet in other embodiments, the mechanical components 74 may be a combination of the rods and small members discussed above, wherein they operate together to form a portion of the touch emulation of the selected item.

As shown in FIG. 9, a spray device 80 may operate to emulate smell as part of the system. The spray device 80 expels in a puff a compound with scent through a nozzle 86. In embodiments, the spray device 80 comprises a plurality of chambers 82 and a mixing chamber 84. The plurality of chambers 82 may receive cartridges with high end compounds. The server is programmed to instruct the spray device 80 to mix particular high end compounds from the chambers 82 within the mixing chamber 84 to emulate a particular scent and puff the compound mixture through the nozzle 86. In other embodiments, the spray device 80 comprises refillable cartridges of aromatic hydrocarbons and reagents loaded within chambers 82, wherein the server is programmed to instruct the spray device 82 to mix predetermined aromatic hydrocarbons and reagents from the chambers 82 to emulate a particular scent and puff it through the nozzle 86.

Embodiments include a 3D virtual shopping environment. However, embodiments also include a virtual reality world that includes a virtual mall with virtual store fronts, in which all ten-dimensions can be expressed. This allows the system to surpass previous expressions of virtual reality being demonstrated in only 3-dimensions. In a ten-dimension environment user created worlds and expressions may be available for purchase, or by subscription status to access the system, or may be used by the retailer for data analytics. A retailer will use the interactions and experiences of customers within the virtual system to enhance its overall decision making when interacting with customers.

Technology utilized to create ten-dimension virtual store in a virtual reality environment includes Virtual Reality devices, such as VR headset units, haptic devices, sensory emulation, brainwave scanners, audio devices, etc. Data repositories may be located on the server for storing user created worlds, templates, interactions, experiences, and the like; computer processors for processing data; network services for connecting users, worlds, businesses, entities, groups, etc.; graphics processing units for processing and rendering graphics within the VR universe.

Definitions and explanations of the multiple dimensions incorporated into the VR universe (1-10):

1st Dimension—Linear.

2nd Dimension—Height.

3rd Dimension—Depth.

4th Dimension—Time. With the ability for users to create different worlds where they can reflect certain timer periods, the dimension of time should be a consideration. With the ability for the user's created worlds to be saved on a server and replayed and interacted with, the past becomes an additional world and interaction medium. So, if users could interact with the saved/stored interactions from their or another user's past, this becomes a real possibility. For instance, the VR world might offer an option to record your life while engaging with the environment over time; other, future users and possibly descendants, could interact with the past recordings of your life; thus, your great-great-great-great grandchildren can interact with you long after you have passed away.

5th Dimension—Possible Worlds. User created worlds/environments, community created worlds/environments are possible. The system may include template preset created worlds/environments.

6th Dimension—A plane of all possible worlds with the same start conditions. A user in the VR environment enters into a world selection portal where they then can choose which world they would like to enter with a start condition when entering the world; for instance, they can enter any of the worlds at the entrance.

7th Dimension—A plane of all possible worlds with different start conditions. A user in the VR environment enters into a world selection portal where they can choose which world they would like to enter with a defined or different start condition for each world entered; for instance, they can enter any of the worlds at any place. Another layer to consider is the timing in which they can enter into these environments—worlds. So, if a server started a user created world at 3:02 a.m. on Jun. 10, 2012, a user could enter this world when it started, or the current date, such as today Apr. 28, 2016; or, any other user defined date. This could be extremely useful for VR environments/worlds that are created to reflect certain time periods.

8th Dimension—A plane of all possible worlds with different start conditions, each branching out infinitely. This dimension demonstrated in VR would involve user created worlds, regardless of their time and starting condition, to all exist within the same universe; where they could possibly interact despite their separated world structure. The infinite possibility is something very possible with never ceasing creations of worlds by users.

9th Dimension—All possible Worlds, starting with all possible start conditions, where the laws of physics are all completely different. This dimension demonstrated in VR would involve user created worlds with infinite start conditions. In such environments, the laws of physics could be manipulated by users for the world they created, the laws could be nonexistent or completely created and defined by the user.

10th Dimension—Infinite possibilities. At this dimension, anything and everything is possible that is imaginable.

Embodiments of the system as described with regard to 3-dimensions may be utilized in a ten-dimension VR environment.

In some embodiments, the systems and methods of the present inventive concepts can be deployed as part of a kiosk or the like at the store's checkout counter, for example, in a “fast lane” at the store checkout. In other embodiments, the systems and methods of the present inventive concepts can be deployed as a public kiosk or the like, for example, positioned at an airport, shopping mall, rail station, or any location having access to a communication network, such as the internet.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, cloud-based infrastructure architecture, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the invention has been shown and described with reference to specific preferred embodiments, it should be understood by those skilled in the art that various changes in form and detail may be made therein without departing from the spirit and scope of the invention as defined by the following claims.

What is claimed is:

1. A system for providing a self-service 3D virtual store, the system comprising:
a server comprising a memory, a database stored in the memory, and a processor, wherein the database contains data for a 3D virtual store front;
wherein the data for the 3D virtual store front comprises data including a plurality of visually perceptible elements, which visually perceptible elements correspond to the 3D virtual store front, particular items in the 3D virtual store front, and avatars;
a computer coupled to the server wherein a user interfaces with the server through the computer, wherein the server is programmed to:
display the 3D virtual store front on the computer coupled to the server;
receive from the computer a signal indicating entrance within the 3D virtual store front;
automatically displaying on the computer coupled to the server A) an avatar associated with the user within the 3D virtual store front on the computer coupled to the server, and B) items for sale within the 3D virtual store, wherein the items are scalable and displayed on virtual shopping displays, racks and shelves;
receive from the computer a signal indicating selection of one of the items within the 3D virtual store front;
automatically creating and displaying a 3D virtual item in response to processing the data including the plurality of visually perceptible elements corresponding to the selected 3D virtual item;
receive from the computer a signal indicating interaction between the avatar and the selected 3D virtual item;
automatically displaying in response to receiving the signal indicating interaction between the avatar and the selected item and processing the data including the plurality of visually perceptible elements corresponding to the selected item and avatar a dynamic and scalable 3D representation of rotating, manipulating and emulating interaction between the avatar and the selected item; and
automatically provide haptic feedback to the user in response to receiving from the computer the signal indicating interaction between the avatar and the selected 3D virtual item, wherein the haptic feedback is provided through a haptic feedback device providing electrical and mechanical feedback.

2. The system of claim 1, wherein the server is further programmed to display collaborative shopping between multiple users within the 3D virtual store front in response to receiving, from a plurality of computers associated with the multiple users, signals indicating collaborative shopping between the multiple users.

3. The system of claim 2, wherein the server is further programmed to emulate interaction between avatars of the multiple users, wherein emulating interaction between avatars includes receiving an interaction signal at the server from the plurality of computers associated with the multiple users through one of a haptic device, audio inputs/outputs, video inputs/outputs, and physiological responses and indicators.

4. The system of claim 1, wherein the server is further programmed to display the avatar having a physical profile associated with the user in response to receiving from a scanning device scanned physical data of the user and automatically storing the scanned physical data in the database.

5. The system of claim 1, wherein the signal indicating interaction between the avatar and the selected 3D virtual item includes one of gesture control, search query or brainwave detection.

6. The system of claim 1, wherein the server is further programmed to dynamically change avatars in response to receiving from the computer a signal indicating changing of the avatar.

7. The system of claim 1, wherein the server is further programmed to display on the computer a user to user interaction in the form of an avatar to avatar interaction within the 3D virtual store front in response to receiving from the computer a signal indicating interaction between the users.

8. The system of claim 1, wherein the selected item is a 3D virtual clothing item.

9. The system of claim 8, wherein the server is programmed to emulate interaction between the avatar and the selected 3D virtual clothing item including the server programmed to display the avatar with the clothing item on the avatar, wherein the clothing item is scaled to fit the avatar and associates a physical size of the clothing item with the physical attributes of the avatar.

10. The system of claim 9, wherein emulating interaction between the avatar and the selected item includes receiving the interaction signal at the server from the computer through one of a haptic device, an avatar fitting and the like.

11. The system of claim 1, wherein the server is programmed to emulate interaction between the avatar and the selected 3D virtual item.

12. The system of claim 11, wherein emulating interaction between the avatar and the selected item includes receiving the interaction signal at the server from the computer through the haptic device.

13. The system of claim 11, wherein emulating interaction between the avatar and the selected item includes sensory emulation.

14. The system of claim 14, wherein sensory emulation includes emulating one or more of sight, sound, touch, smell, and taste.

15. The system of claim 14, wherein the sensory emulation of touch comprises the haptic feedback device having a flexible touchscreen display with 3D touch capability and mechanical components coupled to the flexible display, wherein the server is programmed to move the mechanical components to manipulate the flexible screen to provide physical texture changes to the flexible screen, and wherein the 3D touch operating with the mechanical components provide the touch sensory emulation.

16. The system of claim 14, wherein the sensory emulation of smell comprises a spray device that expels in a puff a compound with scent.

17. The system of claim 17, wherein the spray device comprises cartridges with high end compounds and a mixing chamber, wherein the server is programmed to instruct the spray device to mix particular high end compounds within the mixing chamber to emulate a particular scent.

18. The system of claim 17, wherein the spray device comprises refillable cartridges of aromatic hydrocarbons and reagents, wherein the server is programmed to instruct the spray device to mix a predetermined aromatic hydrocarbons and reagents to emulate a particular scent.

19. A system for providing a self-service virtual store, the system comprising:
a server comprising a memory, a database stored in the memory, and a processor, wherein the database contains data for a virtual store front;
wherein the data for the virtual store front comprises data including a plurality of visually perceptible elements, which visually perceptible elements correspond to the virtual store front and particular items in the virtual store front;
a computer coupled to the server wherein a user interfaces with the server through the computer, wherein the server is programmed to:
display the virtual store front on the computer coupled to the server;
receive from the computer a signal indicating selection of one of the items within the virtual store front;
automatically creating and displaying a virtual item in response to processing the data including the plurality of visually perceptible elements corresponding to the selected virtual item;
receive from the computer a signal indicating interaction with the selected virtual item;
automatically displaying in response to receiving the signal indicating interaction with the selected item and processing the data including the plurality of visually perceptible elements corresponding to the selected item; and
automatically provide haptic feedback to the user in response to receiving from the computer the signal indicating interaction with the selected virtual item, wherein the haptic feedback is provided through a haptic feedback device providing electrical and mechanical feedback.

20. The system of claim 19, wherein the haptic feedback device comprises a flexible touchscreen display with 3D touch capability and mechanical components coupled to the flexible display, wherein the server is programmed to move the mechanical components to manipulate the flexible screen to provide physical texture changes to the flexible screen, and wherein the 3D touch operating with the mechanical components operate to provide touch sensory emulation.
